(19) United States
(12) Patent Application Publication
(10) Pub. No.: US 2024/0399507 A1
(43) Pub. Date: Dec. 5, 2024

(54) MULTI-GANTRY ASYNCHRONOUS PRECISION LASER CUTTING MACHINE

(71) Applicant: Taicang Manaflex Technology Co., Ltd., Taicang City (CN)

(72) Inventors: Fujiang LI, Kunshan City (CN); Yufei HE, Foshan (CN)

(21) Appl. No.: 18/734,236

(22) Filed: Jun. 5, 2024

(30) Foreign Application Priority Data
Jun. 5, 2023 (CN) 202310654388.6

(51) Int. Cl. B23K 26/38; B23K 26/70; B23K 37/02

(52) U.S. Cl. CPC B23K 26/38; B23K 26/702; B23K 37/0211

(57) ABSTRACT

A multi-gantry asynchronous precision laser cutting machine, comprising a horizontally arranged lathe bed, a longitudinal beam and a number of gantry cutting mechanisms; the gantry cutting mechanism comprises a crossbeam, a lifting mechanism and a laser cutting head; a first guide rail is arranged at the top of each of the two longitudinal beams; a first linear motor is arranged at the top of the one longitudinal beam; connecting bases are arranged at the bottom of each end of the crossbeam; the connecting base is connected to a slider of the first guide rail and an actuator component of the first linear motor; a second guide rail is arranged on the side of the crossbeam; a second linear motor is arranged at the top of the crossbeam; the lifting mechanism is connected to a slider of the second guide rail and an actuator component of the second linear motor through a first sliding base; the lifting mechanism comprises a servomotor and a second sliding base; and the laser cutting head is fixed to the second sliding base. The multi-gantry asynchronous precision laser cutting machine disclosed in the present invention is characterized by a compact structure, which improves work efficiency and expands the processing range of the cutting machine.

### CROSS-REFERENCE TO RELATED APPLICATION

This application claims priority to and the benefit of Chinese Utility Model application No. 202310654388.6, filed Jun. 5, 2023, the entire disclosure of which is incorporated by reference in its entirety.

### TECHNICAL FIELD

The present invention relates to the technical field of coil processing, in particular to a multi-gantry asynchronous precision laser cutting machine.

### BACKGROUND

Aluminum metal is gradually replacing copper metal as a conductor in the onboard FPC (Flexible Printed Circuit) or CCS (Cells Contact System, also known as a busbar), a power management system for power batteries, because of its low cost. Among them, in the CCS management system for automotive power batteries, aluminum foils with a thickness of less than 0.25 mm are cut by a laser galvanometer, while aluminum foils with a thickness of more than 0.25 mm should be cut by a laser cutting head. The gantry structure of the cutting machine moves the laser cutting head and completes the cut. Although the method of cutting head plus gantry can cut aluminum foils with a larger thickness, its efficiency is much lower than that of galvanometer cutting, and this cutting machine cannot meet the efficiency requirements of online production. Therefore, improvement is necessary.

### SUMMARY

The present invention aims to provide a multi-gantry asynchronous precision laser cutting machine to overcome the shortcomings in the prior art.

To achieve the above purpose, the present invention provides the following technical solutions:

The present invention discloses a multi-gantry asynchronous precision laser cutting machine, comprising a horizontally arranged lathe bed, a longitudinal beam arranged on both sides at the top of the lathe bed and a number of gantry cutting mechanisms slidably arranged on the longitudinal beam; the gantry cutting mechanism comprises a crossbeam perpendicular to the longitudinal beam, a lifting mechanism slidably arranged on the crossbeam and a laser cutting head connected to the lifting mechanism; a first guide rail is arranged at the top of each of the two longitudinal beams along the length direction, respectively; a first linear motor parallel to the first guide rail is arranged at the top of the one longitudinal beam; connecting bases are arranged at the bottom of each end of the crossbeam; the connecting base is connected to a slider of the first guide rail and an actuator component of the first linear motor; a second guide rail is arranged on the side of the crossbeam along the length direction; a second linear motor is arranged at the top of the crossbeam; the lifting mechanism is connected to a slider of the second guide rail and an actuator component of the second linear motor through a first sliding base; the lifting mechanism comprises a servomotor fixed to the top of the first sliding base and a second sliding base driven and connected to the servomotor; and the laser cutting head is fixed to the second sliding base.

Further, in the multi-gantry asynchronous precision laser cutting machine, the lathe bed is made of granite formed in one piece; cut-outs corresponding to the laser cutting head are arranged at the top surface of the lathe bed, respectively; and the thickness of the lathe bed is greater than 250 mm.

Further, in the multi-gantry asynchronous precision laser cutting machine, the crossbeam is made of aluminum alloy formed in one piece; a number of lightening holes are arranged within the crossbeam.

Further, in the multi-gantry asynchronous precision laser cutting machine, the lightening hole has a triangular cross-section.

Further, in the multi-gantry asynchronous precision laser cutting machine, both the first linear motor and the second linear motor are bilateral linear motors.

Further, in the multi-gantry asynchronous precision laser cutting machine, a collision-prevention device is arranged between the adjacent crossbeams.

Further, in the multi-gantry asynchronous precision laser cutting machine, the collision-prevention device comprises a limit sensor, a buffer device, and a grating scale for monitoring the measured position.

Further, in the multi-gantry asynchronous precision laser cutting machine, organ-type shields are arranged on the longitudinal beam and the crossbeam, respectively.

Compared with the prior art, the present invention has the advantage that the multi-gantry asynchronous precision laser cutting machine is characterized by a compact structure; laser cutting heads corresponding to the crossbeams are arranged, respectively, which can simultaneously complete the cutting of identical patterns, or the cutting of different patterns, as well as the cutting of large formats through the collaboration between the splicing and crossbeam, which improves work efficiency and expands the processing range of the cutting machine and helps to realize the online unmanned processing. In addition, safety measures such as multi-gantry collision prevention are taken to improve the safety of use.

### BRIEF DESCRIPTION OF THE FIGURES

To describe the technical solutions in the embodiments of the present invention more clearly, the following briefly introduces the accompanying drawings required for describing the embodiments. It is clear that the drawings described below are only some embodiments recorded for the present invention. For a person of ordinary skill in the art, other drawings can be obtained according to these drawings without creative labor.

FIG. 1 is a schematic diagram of a structure of a multi-gantry asynchronous precision laser cutting machine according to an embodiment of the present invention.

FIG. 2 is a schematic diagram of a structure of a crossbeam according to an embodiment of the present invention.

FIG. 3 is a schematic diagram of the installation of an organ-type shield according to an embodiment of the present invention.

### DESCRIPTION OF EMBODIMENTS

The following describes the technical solutions in embodiments of the present invention with reference to the drawings in embodiments of the present invention. It is clear that the described embodiments are merely a part rather than all of embodiments of the present invention. Based on the embodiments of the present invention, all other embodiments obtained by a person of ordinary skill in the art without making creative labor fall within the scope of protection of the present invention.

In the description of the present invention, it should be noted that the terms “center”, “upper”, “lower”, “left”, “right”, “vertical”, “horizontal”, “inside” and “outside” indicating the orientation or positional relationship are based on the orientation or positional relationship shown in the accompanying drawings, and are only for the purpose of facilitating the description of the present invention and simplifying the description. The terms shall not be understood as an indication or implication that a device or element referred to shall be constructed and operated with a particular orientation, and therefore shall not be understood as limitations on the present invention. In addition, terms such as “first”, “second” and “third” mentioned below are merely intended for a purpose of description, and shall not be understood as an indication or implication of relative importance.

In the description of the present invention, it should be noted that terms “installation”, “connecting” and “connection” should be understood in a broad sense unless otherwise expressly specified and limited. For example, the “connection” may be a fixed connection, may be a detachable connection, may be an integral connection; may be a mechanical connection, may be an electric connection; may be a direct connection, or may be an indirect connection implemented through a medium, or may be a connection inside two elements. For a person of ordinary skill in the art, the specific meaning of the above terms in the context of the present invention may be understood in specific cases.

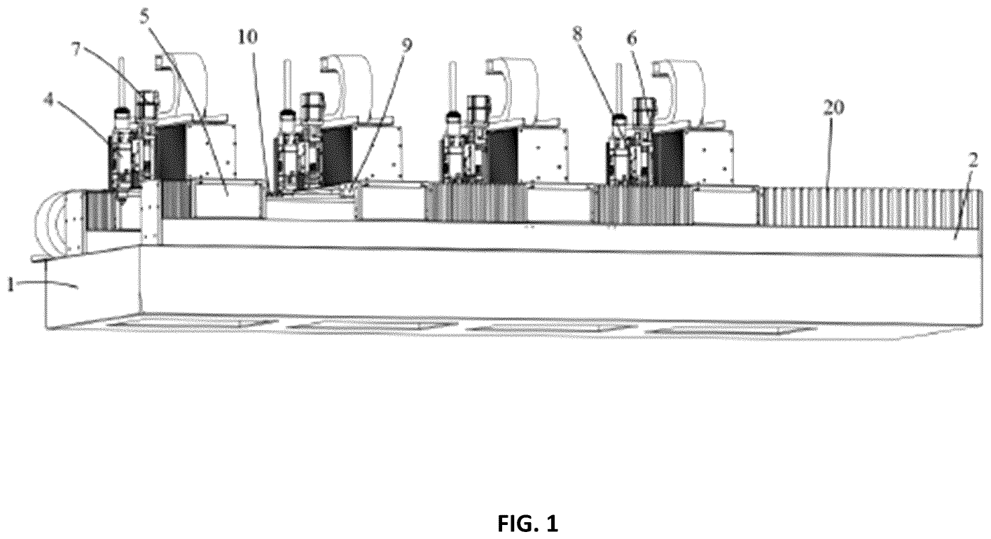

Refer to FIG. 1 to FIG. 3, a multi-gantry asynchronous precision laser cutting machine, comprising a horizontally arranged lathe bed 1, a longitudinal beam 2 arranged on both sides at the top of the lathe bed 1 and four gantry cutting mechanisms slidably arranged on the longitudinal beam 2; the gantry cutting mechanism comprises a crossbeam 3 perpendicular to the longitudinal beam 2, a lifting mechanism slidably arranged on the crossbeam 3 and a laser cutting head 4 connected to the lifting mechanism; a first guide rail (not shown in the drawing) is arranged at the top of each of the two longitudinal beams 2 along the length direction, respectively; a first linear motor (not shown in the drawing) parallel to the first guide rail is arranged at the top of the one longitudinal beam 2; connecting bases 5 are arranged at the bottom of each end of the crossbeam 3; the connecting base 5 is connected to a slider of the first guide rail and an actuator component of the first linear motor; a second guide rail is arranged on the side of the crossbeam 3 along the length direction; a second linear motor is arranged at the top of the crossbeam 3; the lifting mechanism is connected to a slider of the second guide rail and an actuator component of the second linear motor through a first sliding base 6; the lifting mechanism comprises a servomotor 7 fixed to the top of the first sliding base 6 and a second sliding base 8 driven and connected to the servomotor 7; and the laser cutting head 4 is fixed to the second sliding base 8.

In the technical solution, a tank chain is further arranged on the lathe bed and the crossbeam. The specific structure and installation method can be realized through conventional systems and will not be repeated here. The four gantry cutting mechanisms are slidably arranged on the longitudinal beam in sequence, which can meet the processing needs for large formats of 450 mm*2500 mm. The two first guide rails are arranged in parallel, and the first linear motor is also parallel to the two first guide rails. During installation, a laser interferometer is used for precision measurement and to improve the installation precision between the two first guide rails and between the first guide rail and the first linear motor, thus improving the movement precision of the gantry cutting mechanism, which is equivalent to improving the processing precision of the laser cutting head. The second guide rail and the second linear motor are installed by the same method. All of the first guide rail, the second guide rail, the first linear motor, and the second linear motor are of a structure realized through conventional systems. Each of the crossbeams corresponds to the independently arranged first linear motor, which can simultaneously complete the cutting of identical patterns, or the cutting of different patterns, as well as the cutting of large formats through the collaboration between the splicing and crossbeam, which improves work efficiency and expands the processing range of the cutting machine. The aluminum foil is fed by conventional methods such as roll-to-roll and so on, which helps to realize online unmanned processing. The servomotor is connected to a lead screw through a coupling and the like. The side of the second sliding base away from the laser cutting head is connected to a nut of the lead screw, and the laser cutting head is driven to go up and down through the forward and reverse rotation of the servomotor. Wherein, a third guide rail is arranged between the second sliding base and the first sliding base so that the stability and precision of the lifting of the laser cutting head are improved. The multi-gantry asynchronous precision laser cutting machine is characterized by a compact structure, laser cutting heads corresponding to the crossbeams are arranged, respectively, which can simultaneously complete the cutting of identical patterns, or the cutting of different patterns, as well as the cutting of large formats through the collaboration between the splicing and crossbeam, which improves work efficiency and expands the processing range of the cutting machine and helps to realize the online unmanned processing.

As an example, refer to FIG. 1, the lathe bed 1 is made of granite formed in one piece; cut-outs corresponding to the laser cutting head 4 are arranged at the top surface of the lathe bed, respectively; and the thickness of the lathe bed 1 is greater than 250 mm.

In the technical solution, the granite is characterized by a compact structure and well-closed formation, high strength, good rigidity, and a very small expansion coefficient. In addition, it has the advantages of not being easily deformed, not being easily magnetized, and being completely free of internal stress. Four straight slots are arranged at the top of the lathe bed as cut-outs to avoid any damage to the lathe bed during processing. In addition, processing scrap, etc. will fall into the cut-outs to avoid interfering with subsequent processing of aluminum foils. The thickness of the lathe bed is greater than 250 mm to ensure the overall rigidity of the lathe bed. The longitudinal beams are fixed to both sides of the top surface of the lathe bed by bolts, etc., for mounting the corresponding first guide rail and first linear motor.

As an example, refer to FIG. 1 to FIG. 3, the crossbeam 3 is made of aluminum alloy formed in one piece; a number of lightening holes 31 are arranged within the crossbeam.

In the technical solution, the crossbeam is made of 7075 and other conventional 7xxx aluminum alloy, and with the lightweight design of lightening holes, the deadweight is reduced while the strength is ensured, which improves the dynamic performance of the crossbeam movement.

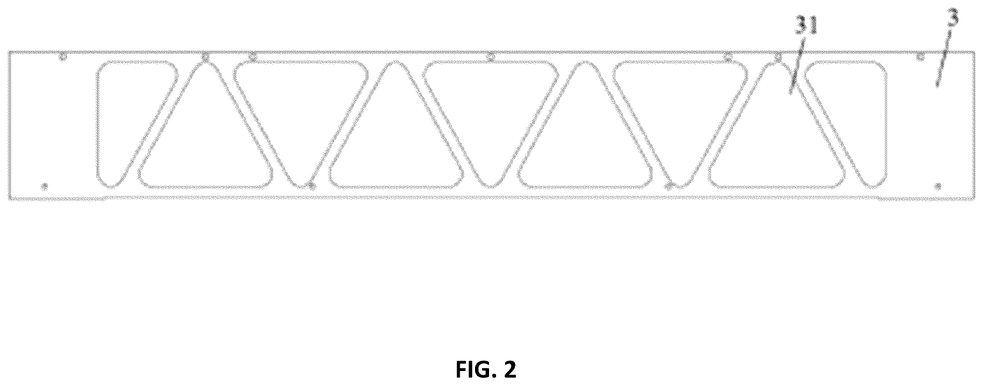

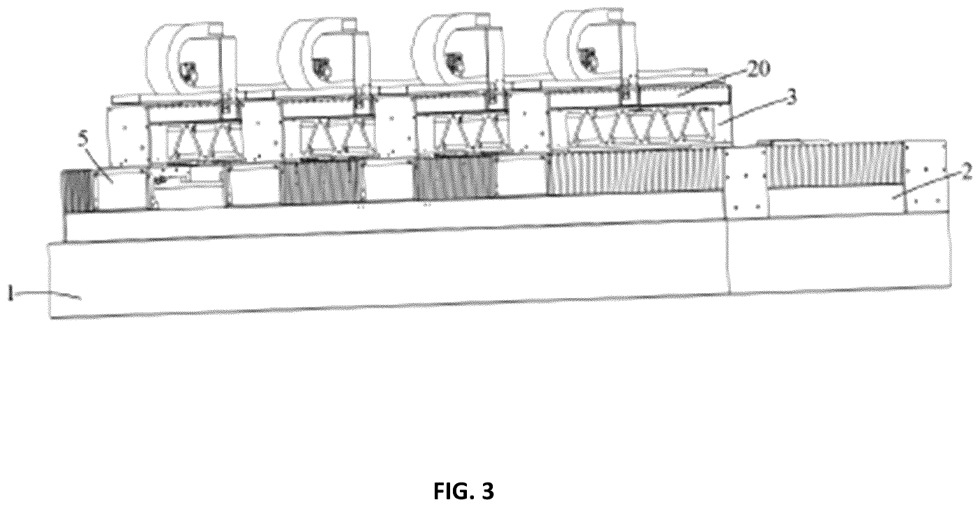

As an example, refer to FIG. 2 and FIG. 3, the lightening hole 31 has a triangular cross-section.

In the technical solution, the triangle is solid, firm, and pressure-resistant. After the lightening holes are processed, the crossbeam still has enough strength. The side of the crossbeam near the laser cutting head is connected to a mounting plate for mounting the second guide rail and the like. The mounting plate blocks the corresponding end of the lightening hole to prevent dust and the like from entering the second guide rail and the second linear motor from the lightening hole.

As an example, both the first linear motor and the second linear motor are bilateral linear motors.

In the technical solution, both the first linear motor and the second linear motor are selected from existing bilateral linear motors, which are characterized by high efficiency, high precision, and high dynamic response, realizing the overall efficient, precise, and fast movement control of the cutting machine, and improving the processing precision and efficiency. Wherein, the actuator component of the second linear motor is arranged near the side where the laser cutting head is located, and is connected to the first sliding base to drive the lifting mechanism and the laser cutting head to move back and forth along the length direction of the crossbeam.

As an example, refer to FIG. 1, a collision-prevention device is arranged between the adjacent crossbeams 3.

In the technical solution, the collision-prevention device can avoid the collision between the adjacent crossbeams, protect the laser cutting head, and prolong the service life.

As an example, refer to FIG. 1, the collision-prevention device comprises a limit sensor 9, a buffer device 10, and a grating scale for monitoring the measured position (not shown in the drawing).

In the technical solution, the limit sensor is selected from proximity sensors, the buffer device is a mechanical buffer limit, selected from hydraulic buffers, and the grating scale is selected from absolute grating scales. Wherein, the principle of the proximity sensor and the absolute grating scale can be realized through conventional systems and will not be repeated here. The collision prevention and safety measures such as multiple crossbeams are taken, which improves safety during use.

As an example, refer to FIG. 1 and FIG. 3, organ-type shields 20 are arranged on the longitudinal beam 2 and the crossbeam 3, respectively.

In the technical solution, the organ-type shield is of a regular structure. Scaling plates are arranged on both sides of the crossbeam and the longitudinal beam. The corresponding end of the organ-type shield is fixed to the corresponding sealing plate. Wherein, the organ-type shield on the longitudinal beam is selected from gate-type organ-type shields. The end close to the gantry cutting mechanism is fixed to the connecting base of the crossbeam through its end plate. The connecting base is also of a gate-type structure, comprising a top plate and two side plates. Wherein, the top surface of the top plate is fixed to the slider of the corresponding first guide rail and the actuator component of the first linear motor. The side plates cooperate with the organ-type shield to isolate the slider of the first guide rail and the first linear motor from the outside and to prevent dust and the like from entering and ensure its running precision. A groove is arranged on the outer side of the side plate, which is convenient to be connected to the organ-type shield by bolts. For the 7-shaped organ-type shield on the crossbeam, only the side and top of the crossbeam are isolated, and a mounting plate is arranged to block the lightening holes, which isolates the second guide rail and the second linear guide rail from the outside.

In summary, the multi-gantry asynchronous precision laser cutting machine is characterized by a compact structure; laser cutting heads corresponding to the crossbeams are arranged, respectively, which can simultaneously complete the cutting of identical patterns, or the cutting of different patterns, as well as the cutting of large formats through the collaboration between the splicing and crossbeam, which improves work efficiency and expands the processing range of the cutting machine and helps to realize the online unmanned processing. In addition, collision prevention and safety measures such as multiple crossbeams are taken, which improves safety during use.

It should be noted that, as used herein, the terms “including”, “comprising”, or any other variant thereof, are intended to cover non-exclusive inclusion, such that a process, method, article, or apparatus comprising a set of elements includes not only those elements, but also other elements that are not expressly listed, or that are inherent to such process, method, article or apparatus. Without further limitation, an element defined by the statement “comprising a . . . ” does not preclude the existence of another identical element in the process, method, article, or apparatus comprising the element.

What is claimed is:

1. A multi-gantry asynchronous precision laser cutting machine, comprising:
a horizontally arranged lathe bed,
a longitudinal beam arranged on both sides at the top of the lathe bed and a number of gantry cutting mechanisms slidably arranged on the longitudinal beam;
the gantry cutting mechanism comprises a crossbeam perpendicular to the longitudinal beam,
a lifting mechanism slidably arranged on the crossbeam and a laser cutting head connected to the lifting mechanism;
a first guide rail is arranged at the top of each of the two longitudinal beams along the length direction, respectively;
a first linear motor parallel to the first guide rail is arranged at the top of the one longitudinal beam;
connecting bases are arranged at the bottom of each end of the crossbeam;
the connecting base is connected to a slider of the first guide rail and an actuator component of the first linear motor;
a second guide rail is arranged on the side of the crossbeam along the length direction;
a second linear motor is arranged at the top of the crossbeam;
the lifting mechanism is connected to a slider of the second guide rail and an actuator component of the second linear motor through a first sliding base;
the lifting mechanism comprises a servomotor fixed to the top of the first sliding base and a second sliding base driven and connected to the servomotor; and
the laser cutting head is fixed to the second sliding base.

2. A multi-gantry asynchronous precision laser cutting machine according to claim 1, wherein the lathe bed is made of granite formed in one piece;
cut-outs corresponding to the laser cutting head are arranged at the top surface of the lathe bed, respectively; and
the thickness of the lathe bed is greater than 250 mm.

3. A multi-gantry asynchronous precision laser cutting machine according to claim 1, wherein the crossbeam is made of aluminum alloy formed in one piece;
a number of lightening holes are arranged within the crossbeam.

4. A multi-gantry asynchronous precision laser cutting machine according to claim 3, wherein the lightening hole has a triangular cross-section.

5. A multi-gantry asynchronous precision laser cutting machine according to claim 1, wherein both the first linear motor and the second linear motor are bilateral linear motors.

6. A multi-gantry asynchronous precision laser cutting machine according to claim 1, wherein a collision-prevention device is arranged between the adjacent crossbeams.

7. A multi-gantry asynchronous precision laser cutting machine according to claim 6, wherein the collision-prevention device comprises a limit sensor, a buffer device, and a grating scale for monitoring the measured position.

8. A multi-gantry asynchronous precision laser cutting machine according to claim 1, wherein organ-type shields are arranged on the longitudinal beam and the crossbeam, respectively.
